(19) United States
(12) Patent Application Publication
(10) Pub. No.: US 2015/0111070 A1
(43) Pub. Date: Apr. 23, 2015

(54) STARTING APPARATUS AND METHOD OF FUEL CELL VEHICLE

(71) Applicant: Hyundai Motor Company, Seoul (KR)

(72) Inventors: Boung Ho Min, Yongin (KR); Ho Sung Kang, Seoul (KR); Ji Tae Kim, Yongin (KR)

(21) Appl. No.: 14/296,840

(22) Filed: Jun. 5, 2014

(30) Foreign Application Priority Data
Oct. 18, 2013 (KR) 10-2013-0124595

(51) Int. Cl. H01M 8/04; H01M 16/00

(52) U.S. Cl. CPC H01M 8/04223; H01M 16/003; H01M 2250/20
USPC 429/9; 429/429

(57) ABSTRACT

A starting apparatus of a fuel cell vehicle includes: a fuel cell stack that supplies a driving voltage to a motor; a low voltage battery that supplies a starting voltage to an air blower; and a high voltage DC converter that boosts at least one of the driving voltage and the starting voltage and selectively transmits the boosted voltage to the motor and the air blower. A method of starting the fuel cell vehicle includes transmitting the starting voltage to the high voltage DC converter and boosting the starting voltage when entering a starting mode; driving the air blower with the boosted starting voltage; generating the driving voltage according to starting of the fuel cell stack; blocking the starting voltage to the high voltage DC converter if the driving voltage is equal to or larger than a predetermined voltage value; and supplying the driving voltage to the motor.

### CROSS-REFERENCE TO RELATED APPLICATION

This application claims priority under 35 U.S.C. §119(a) to and the benefit of Korean Patent Application No. 10-2013-0124595 filed in the Korean Intellectual Property Office on Oct. 18, 2013, the entire contents of which are incorporated herein by reference.

### BACKGROUND

(a) Field of the Invention

The present invention relates to a starting apparatus and method of a fuel cell vehicle.

(b) Description of the Related Art

A fuel cell is a power generating system that directly converts chemical energy of fuel into electric energy. The fuel cell is configured by continuously disposing unit cells, each of which is formed of a pair of anode and cathode with electrolyte interposed therebetween. Electricity is generated through a chemical reaction of an ionized material by supplying hydrogen to the anode of the unit cell and oxygen to the cathode of the unit cell. Since the fuel cell is not subjected to a combustion reaction of fossil fuel, the fuel cell does not discharge harmful substances, and has high power generation efficiency, and thereby is suitable as a power source of a vehicle.

A power supply unit of a vehicle to which the fuel cell is applied uses a fuel cell stack as a primary power source, and a chargeable and dischargeable super capacitor or high voltage battery as a secondary power source. The vehicle including the aforementioned configuration needs to supply air together with hydrogen, which is a reaction gas, to the fuel cell at the time of the starting.

However, since a high voltage driving component, such as an air blower, may not be driven with output of the fuel cell before the fuel cell reaches a normal operation state, air containing oxygen is supplied to the fuel cell by driving the air blower by using power of the secondary power source in a state where hydrogen is supplied to the fuel cell. Further, when regeneration energy is generated in a power module, such as a motor or an inverter, by deceleration when the vehicle is travelling, the secondary power source is charged by the regeneration energy.

The above information disclosed in this Background section is only for enhancement of understanding of the background of the invention and therefore it may contain information that does not form the prior art that is already known in this country to a person of ordinary skill in the art.

### SUMMARY

However, in general, a fuel cell and a high voltage battery are very expensive, so that a cost of the fuel cell vehicle using both the fuel cell and the high voltage battery is inevitably increased.

The present invention has been made in an effort to provide a starting apparatus and method capable of starting a vehicle only with a low voltage battery for driving an inside of the vehicle without the need to use a high voltage battery.

An exemplary embodiment of the present invention provides a starting apparatus of a fuel cell vehicle, which drives a motor by receiving oxygen through an air blower in a state where hydrogen is supplied to a fuel cell stack, the apparatus including: the fuel cell stack configured to supply a driving voltage to the motor; a low voltage battery configured to supply a starting voltage to the air blower; and a high voltage DC converter configured to boost at least one of the driving voltage and the starting voltage and selectively transmit the boosted voltage to the motor and the air blower.

The starting apparatus may further include: a first switch configured to transmit the driving voltage to the high voltage DC converter; and a second switch configured to transmit the starting voltage to the high voltage DC converter. Further, the starting apparatus may further include a controller configured to generate a first control signal that activates (i.e., turns on) the first switch when the driving voltage has a value equal to or larger than a predetermined voltage value, and generate a second control signal that activates (i.e., turns on) the second switch when the driving voltage has a value lower than the predetermined voltage value.

Further, the controller may control a boosting rate of the high voltage DC converter for the starting voltage. Further, the low voltage battery may have a voltage level equal to or lower than 50 V.

Further, the starting apparatus may further include an inverter configured to receive the boosted driving voltage from the high voltage DC converter, convert the received boosted driving voltage into an AC voltage, and transmit the converted voltage to the motor. Further, the starting apparatus may further include a low voltage converter configured to receive a regeneration voltage generated by regenerative braking of the motor through the inverter, and convert the received regeneration voltage into the voltage having a voltage level for driving an electrical load. In particular, the low voltage battery may be charged by the regeneration voltage.

Further, another exemplary embodiment of the present invention provides a method of starting a fuel cell vehicle, which includes a fuel cell stack configured to receive oxygen through an air blower in a state where hydrogen is supplied and supply a driving voltage driving a motor, a low voltage battery configured to supply a starting voltage to the air blower, and a high voltage DC converter configured to boost at least one of the driving voltage and the starting voltage, the method including: transmitting the starting voltage to the high voltage DC converter and boosting the starting voltage when entering a starting mode; driving the air blower with the boosted starting voltage; generating the driving voltage according to starting of the fuel cell stack; blocking a supply of the starting voltage to the high voltage DC converter when the driving voltage has a value equal to or larger than a predetermined voltage value; and supplying the driving voltage to the motor.

In particular, the step of transmitting the starting voltage may include blocking a connection between the fuel cell stack and the high voltage DC converter. Further, the method may further include: determining whether the voltage level of the boosted starting voltage is larger than a predetermined level when the driving voltage has the value lower than the predetermined voltage value; and increasing a supply time for supplying the starting voltage to the high voltage DC converter by a predetermined time when the voltage level of the boosted starting voltage is larger than the predetermined level.

Further, the method may further include increasing a boosting rate of the high voltage DC converter by a predetermined size when the voltage level of the boosted starting voltage is lower than the predetermined level.

According to the exemplary embodiment of the present invention, it is possible to start a vehicle only with a low voltage battery for driving the inside of the vehicle without using a high voltage battery. Accordingly, it is possible to decrease costs of the fuel cell vehicle.

### BRIEF DESCRIPTION OF THE DRAWINGS

FIG. 1 is a block diagram illustrating a starting apparatus of a fuel cell vehicle according to an exemplary embodiment of the present invention.

FIG. 2 is a flowchart illustrating a starting method of the fuel cell vehicle according to the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, the present invention will be described more fully hereinafter with reference to the accompanying drawings, in which exemplary embodiments of the invention are shown.

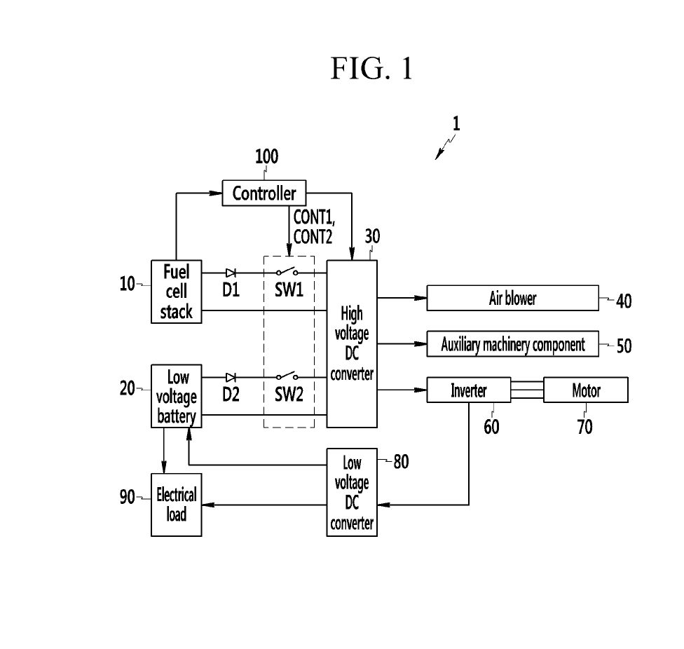

FIG. 1 is a block diagram illustrating a starting apparatus of a fuel cell vehicle according to an exemplary embodiment of the present invention.

Referring to FIG. 1, a starting apparatus 1 of a fuel cell vehicle according to an exemplary embodiment of the present invention includes a fuel cell stack 10, a low voltage battery 20, first and second diodes D1 and D2, first and second switches SW1 and SW2, a high voltage DC converter 30, an air blower 40, an auxiliary machinery component 50, an inverter 60, a motor 70, a low voltage DC converter 80, an electrical load 90, and a controller 100.

The fuel cell stack 10 supplies a driving voltage that drives the motor 70 as a power source of the fuel cell vehicle. The low voltage battery 20 supplies a starting voltage for starting the fuel cell vehicle. The low voltage battery 20 may supply a voltage equal to or lower than about 50 V. Further, the low voltage battery 20 may receive a regeneration voltage from the low voltage DC converter 80 to be charged. The low voltage battery 20 may supply the charged regeneration voltage to the electrical load 90.

The first and second diodes D1 and D2 prevent a reverse current from flowing to the fuel cell stack 10 and the low voltage battery 20. A first switch SW1 is turned on according to a first control signal SW1 to electrically connect the fuel cell stack 10 and the high voltage DC converter 30. A second switch SW1 is turned on according to a second control signal SW2 to electrically connect the low voltage battery 20 and the high voltage DC converter 30.

The high voltage DC converter 30 receives the driving voltage and the starting voltage from at least one of the fuel cell stack 10 and the low voltage battery 20, and converts the received voltage into a DC voltage having a predetermined size and outputs the converted voltage. For example, the high voltage DC converter 30 boosts the starting voltage of the low voltage battery 20 by a predetermined ratio and outputs the boosted starting voltage in a starting mode. To this end, the high voltage DC converter 30 may include a boost converter (not illustrated). For example, the boost converter may boost the starting voltage of 50 V to about 100 to 800 V.

Further, the high voltage DC converter 30 may drop or boost the driving voltage of the fuel cell stack 10 according to a rotation speed of the motor 70 in a driving mode. To this end, the high voltage DC converter 30 may include a buck-boost converter (not illustrated).

The high voltage DC converter 30 is electrically connected with the air blower 40, the auxiliary machinery component 50, and the inverter 60 to selectively supply the driving voltage and the starting voltage.

The air blower 40 receives the starting voltage from the high voltage DC converter 30 and is driven by the starting voltage to supply air containing oxygen to the fuel cell stack 10. The auxiliary machinery component (fuel cell BOP) 50 includes components necessary to start the fuel cell stack 10. For example, the auxiliary machinery component 50 may include a water pump, a radiator fan, and a hydrogen recirculation blower.

In the exemplary embodiment of the present invention, it is described that the air blower 40 is discriminated from the auxiliary machinery component 50 for convenience of description, but the air blower 40 may be included in the auxiliary machinery component 50. The auxiliary machinery component 50 may also be driven by the starting voltage to start the fuel cell stack 10.

The inverter 60 receives the driving voltage from the high voltage DC converter 30 to provide a voltage necessary for driving the motor 70. To this end, the inverter 60 converts the driving voltage to a 3-phase AC voltage having a predetermined size and supplies the converted voltage to the motor 70.

The motor 70 receives the driving voltage from the inverter 60 to drive the fuel cell vehicle. The motor 70 supplies the regeneration voltage regenerated through regenerative braking to the low voltage battery 20 and the electrical load 90.

The low voltage DC converter 80 receives the regeneration voltage generated from the motor 70 through the inverter 60, and converts the received regeneration voltage into a DC voltage having a predetermined size. The low voltage DC converter 80 may boost the regeneration voltage to have a voltage size necessary for driving the electrical load 90. The low voltage DC converter 80 transmits the regeneration voltage to the low voltage battery 20 and the electrical field 90.

The electrical load 90 includes components, such as a motor driven power steering (MDPS) device, a radiator fan, and a headlight (not illustrated), necessary for driving a vehicle. The electrical load 90 is driven by receiving the voltage having the predetermined size from the low voltage battery 20 or the low voltage DC converter 80

The controller 100 generates first and second control signals CONT1 and CONT2 that control on/off of each of the first and second switches SW1 and SW2 according to a size of the driving voltage output from the fuel cell stack 10. When the size of the driving voltage is equal to or larger than a predetermined voltage value, the controller 100 activates and outputs the first control signal CONT1, and when the size of the driving voltage is equal to or lower than the predetermined voltage value, the controller 100 activates and outputs the second control signal CONT2. In particular, the predetermined voltage value may be a minimum voltage value for driving the motor 70.

Further, the controller 100 may control a boosting rate for the starting voltage of the high voltage DC converter 30. For example, when the amount of oxygen supplied to the fuel cell stack 10 is equal to or lower than a reference amount, the controller 100 may increase a boosting rate of the starting voltage.

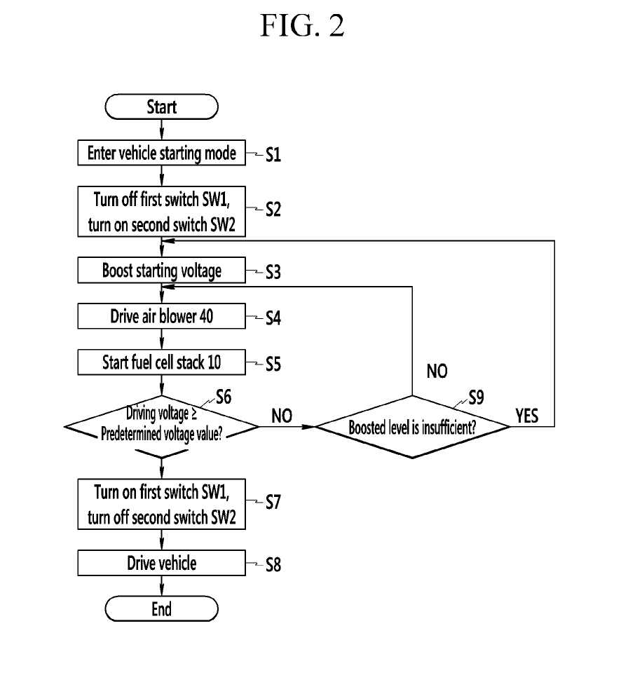

FIG. 2 is a flowchart illustrating a starting method of the fuel cell vehicle according to the exemplary embodiment of the present invention.

Referring to FIG. 2, first, a starting key is inserted into the vehicle to enter a starting mode (step S1). In this case, the controller 100 maintains the first switch SW1 in an off state, and switches the second switch SW2 to an on state. Then, the starting voltage is transmitted from the low voltage battery 20 to the high voltage DC converter 30.

Next, the high voltage DC converter 30 boosts the starting voltage to a predetermined size and transmits the boosted starting voltage to the air blower 40 (step S2). For example, the high voltage DC converter 30 may boost the starting voltage of 12 V to a voltage of 100 V.

Then, the air blower 40 is driven by the starting voltage and supplies air containing oxygen to the fuel cell stack 10 (step S3). In this case, the auxiliary machinery component 50 may be also driven, so that an operation necessary for supplying hydrogen to the fuel cell stack 10 and other starting is performed.

Then, the fuel cell stack 10 is started, so that a size of the driving voltage is increased (step S4). Next, the controller 100 determines whether the driving voltage generated from the fuel cell stack 10 is equal to or larger than a predetermined voltage value (step S5).

As a result of the determination, when the driving voltage is equal to or larger than the predetermined voltage value, the controller 100 switches the first switch SW1 to a turn-on state, and the second switch SW2 to a turn-off state. Then, the driving voltage is transmitted to the high voltage DC converter 30.

The high voltage DC converter 30 boosts or drops the driving voltage to a predetermined size and transmits the boosted or dropped driving voltage to the inverter 60. The driving voltage is converted into the driving voltage having a size necessary for driving the motor 70 through the inverter 60 to be transmitted to the motor 70. The motor 70 drives the vehicle with the driving voltage (step S6).

In the meantime, as the result of the determination in step S5, when the driving voltage is lower than the predetermined voltage value, the controller 100 determines whether a voltage level of the starting voltage boosted by the high voltage DC converter 30 is insufficient (step S7). To this end, the controller 100 may determine whether a voltage level of the boosted starting voltage is larger than a predetermined voltage level.

As a result of the determination, when the voltage level of the boosted starting voltage is lower than the predetermined voltage level, the controller 100 increases a boosting rate of the high voltage DC converter 30 and increases the boosting level of the starting voltage (step S8). Then, the starting voltage is further boosted more than the level in step S2 to be supplied to the air blower 40.

In the meantime, when the voltage level of the boosted starting voltage is not lower than the predetermined voltage level, but oxygen is insufficiently supplied to the fuel cell stack 10 in step S7, the controller 100 maintains the turn-on state of the second switch SW2 for a predetermined time (step S9). Then, oxygen may be sufficiently supplied to the fuel cell stack 10.

That is, according to the exemplary embodiment of the present invention, the power source of the motor 70 may be implemented only by the fuel cell stack 10, and the fuel cell stack 10 may be started by using the low voltage battery 20 having 50 V or lower driving the electrical load 90, instead of a high voltage battery having 100 V or higher, thereby decreasing costs of the fuel cell vehicle.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A starting apparatus of a fuel cell vehicle, which drives a motor by receiving oxygen through an air blower in a state where hydrogen is supplied to a fuel cell stack, the starting apparatus comprising:
the fuel cell stack configured to supply a driving voltage to the motor;
a low voltage battery configured to supply a starting voltage to the air blower; and
a high voltage DC converter configured to boost at least one of the driving voltage and the starting voltage and selectively transmit the boosted voltage to the motor and the air blower.

2. The starting apparatus of claim 1, further comprising:
a first switch configured to transmit the driving voltage to the high voltage DC converter; and
a second switch configured to transmit the starting voltage to the high voltage DC converter.

3. The starting apparatus of claim 2, further comprising:
a controller configured to generate a first control signal that activates the first switch when the driving voltage has a value equal to or larger than a predetermined voltage value, and generate a second control signal that activates the second switch when the driving voltage has a value lower than the predetermined voltage value.

4. The starting apparatus of claim 3, wherein:
the controller controls a boosting rate of the high voltage DC converter for the starting voltage.

5. The starting apparatus of claim 1, wherein:
the low voltage battery has a voltage level equal to or lower than 50 V.

6. The starting apparatus of claim 1, further comprising:
an inverter configured to receive the boosted driving voltage from the high voltage DC converter, convert the received boosted driving voltage into an AC voltage, and transmit the converted voltage to the motor.

7. The starting apparatus of claim 6, further comprising:
a low voltage converter configured to receive a regeneration voltage generated by regenerative braking of the motor through the inverter, and convert the received regeneration voltage into the voltage having a voltage level for driving an electrical load.

8. The starting apparatus of claim 7, wherein:
the low voltage battery is charged by the regeneration voltage.

9. A method of starting a fuel cell vehicle, which comprises a fuel cell stack configured to receive oxygen through an air blower in a state where hydrogen is supplied and supply a driving voltage driving a motor, a low voltage battery configured to supply a starting voltage to the air blower, and a high voltage DC converter configured to boost at least one of the driving voltage and the starting voltage, the method comprising:
transmitting the starting voltage to the high voltage DC converter and boosting the starting voltage when entering a starting mode;
driving the air blower with the boosted starting voltage;
generating the driving voltage according to starting of the fuel cell stack;
blocking a supply of the starting voltage to the high voltage DC converter when the driving voltage has a value equal to or larger than a predetermined voltage value; and
supplying the driving voltage to the motor.

10. The method of claim 9, wherein:
the step of transmitting the starting voltage includes blocking a connection between the fuel cell stack and the high voltage DC converter.

11. The method of claim 9, further comprising:
determining whether the voltage level of the boosted starting voltage is larger than a predetermined level when the driving voltage has the value lower than the predetermined voltage value; and
increasing a supply time for supplying the starting voltage to the high voltage DC converter by a predetermined time when the voltage level of the boosted starting voltage is larger than the predetermined level.

12. The method of claim 11, further comprising:
increasing a boosting rate of the high voltage DC converter by a predetermined size when the voltage level of the boosted starting voltage is lower than the predetermined level.
